(19) United States
(12) Patent Application Publication
(10) Pub. No.: US 2017/0139183 A1
(43) Pub. Date: May 18, 2017

(54) Photographic Objective Lens And Photographic Equipment

(71) Applicant: HAN'S LASER TECHNOLOGY INDUSTRY GROUP CO., LTD., Shenzhen (CN)

(72) Inventors: Jiaying LI, Shenzhen (CN); Chaoming ZHOU, Shenzhen (CN); Yunfeng GAO, Shenzhen (CN)

(73) Assignee: HAN'S LASER TECHNOLOGY INDUSTRY GROUP CO., LTD., Shenzhen (CN)

(21) Appl. No.: 15/322,538

(22) PCT Filed: Jul. 28, 2014
(86) PCT No.: PCT/CN2014/083136

§ 371 Date: Dec. 28, 2016

(51) Int. Cl. G02B 13/00

(52) U.S. Cl. CPC G02B 13/001

(57) ABSTRACT

A photographic objective lens (100), comprising a first lens (110), a second lens (120), a third lens (130), a fourth lens (140), a fifth lens (150), a sixth lens (160) and a seventh lens (170) sequentially arranged along a transmission direction of incident light. The first lens (110) is a meniscus negative lens and comprises a first curved surface (111) and a second curved surface (112); the second lens (120) is a positive lens and comprises a third curved surface (121) and a fourth curved surface (122); the third lens (130) is a meniscus negative lens and comprises a fifth curved surface (131) and a sixth curved surface (132); the fourth lens (140) is a positive lens and comprises a seventh curved surface (141) and an eighth curved surface (142); the fifth lens (150) is a double-concave negative lens and comprises a ninth curved surface (151) and a tenth curved surface (152); the sixth lens (160) is a meniscus positive lens and comprises an eleventh curved surface (161) and a twelfth curved surface (162); and the seventh lens (170) is a double-concave positive lens and comprises a thirteenth curved surface (171) and a fourteenth curved surface (172). The photographic objective lens (100) mentioned above can be directly used for underwater photography, has no need of a sealing box and is simple in terms of view finding and large in view finder coverage, and an underwater field-of-view angle thereof reaches 62 degrees.

### FIELD OF THE INVENTION

The present disclosure relates to a photographic technology, and more particularly, relates to a photographic objective lens and a photographic equipment.

### BACKGROUND OF THE INVENTION

In a regular underwater photography, a photographic objective lens (even the whole photography machine) is generally placed into a sealing box having a transparent window. There exists two problems: first, the refractive index n of the sea water (fresh water) is 1.33, thereby reducing ¼ of the field of view of the photography; second, the photography range of the camera is limited due to the existence of the sealing box.

### SUMMARY

Therefore, it is necessary to provide a photographic objective lens and a photographic equipment having a greater underwater visual field view.

A photographic objective lens includes, successively arranged along a transmission direction of an incident light; a first lens which is a meniscus negative lens and includes a first curved surface and a second curved surface, both the first curved surface and the second curved surface are convex to an object side; the second lens which is a positive lens and includes a third curved surface and a fourth curved surface, both the third curved surface and the fourth curved surface are convex to an image side; the third lens which is a meniscus negative lens and includes a fifth curved surface and a sixth curved surface, both the fifth curved surface and the sixth curved surface are convex to the object side; the fourth lens which is a positive lens and includes a seventh curved surface and an eighth curved surface, the seventh curved surface is convex to the object side, and the eighth curved surface is convex to the image side; the fifth lens which is a double-concave negative lens and includes a ninth curved surface and a tenth curved surface, the ninth curved surface is convex to the image side, and the tenth curved surface is convex to the object side; the sixth lens which is a meniscus positive lens and includes an eleventh curved surface and a twelfth curved surface, both the eleventh curved surface and the twelfth curved surface are convex to the image side; the seventh lens which is a double-concave positive lens and includes a thirteenth curved surface and a fourteenth curved surface, the thirteenth curved surface is convex to the object side, and the fourteenth curved surface is convex to the image side; wherein the first to the seventh lenses are coaxially arranged along the transmission direction of the incident light, the first to the fourteenth curved surfaces are arranged along the transmission direction of the incident light in a sequence; wherein the first to the seventh lenses have ratios of refractive index to Abbe number of 1.5/64, 1.67/32, 1.62/56, 1.63/55, 1.75/28, 1.62/60, and 1.62/60, with an allowable tolerance of 10%, an upper deviation of +5%, and a lower deviation of −5%.

According to one embodiment, a central distance between the second curved surface and the third curved surface, a central distance between the fourth curved surface and the fifth curved surface, a central distance between the sixth curved surface and the seventh curved surface, a central distance between the eighth curved surface and the ninth curved surface, a central distance between the tenth curved surface and the eleventh curved surface, and a central distance between the twelfth curved surface and the thirteenth curved surface are 4, 0.2, 4, 2, 1.5, and 0.2 millimeters, respectively, with an allowable tolerance of 10%, an upper deviation of +5%, and a lower deviation of −5%.

According to one embodiment, radiuses of curvature of the first to the fourteenth curved surfaces are 75, 10, −300, −30, 8.7, 5.6, 14.8, −9, −8.3, 22, −29, −9, 28, and −23 millimeters, respectively, with an allowable tolerance of 10%, an upper deviation of +5%, and a lower deviation of −5%

According to one embodiment, central thicknesses of the first to the seventh lenses are 4, 9, 2, 7, 1, 2, and 2.6 millimeters, respectively, with an allowable tolerance of 10%, an upper deviation of +5%, and a lower deviation of −5%.

According to one embodiment, clear apertures of the first to the seventh lenses are 20, 12, 8, 8, 10, 10, and 13 millimeters, respectively, with an allowable tolerance of 10%, an upper deviation of +5%, and a lower deviation of −5%

According to one embodiment, the first to the fourteenth curved surfaces are spherical surfaces.

According to one embodiment, external diameters of the first to the seventh lenses are less than 20 millimeters.

According to one embodiment, the first to the seventh lenses are rotational symmetry about an axis of the incident light.

According to one embodiment, the photographic objective lens satisfies the following conditions: f=10 mm, D/f=1/3.0, 2ω=62°, wherein f is a focal length of the lens, D is an entrance pupil diameter, D/f is a relative aperture, and 2ω is an underwater visual field angle.

A photographic equipment includes the photographic objective mentioned above.

The foregoing photographic objective lens and the photographic equipment can be directly used for underwater photography using the seawater (fresh water) as a medium of the photographic objective lens, therefore the sealing box is can be omitted. The advantages thereof includes a free framing, a large viewing range, a simple structure, and it can be sub-miniaturized, thus it is easy for assembly and storing.

### BRIEF DESCRIPTION OF THE DRAWINGS

FIG. 1 is a side view of a photographic objective lens according to an embodiment;

FIG. 2 is a graphic diagram showing astigmatism of the photographic objective lens of FIG. 1;

FIG. 3 is a graphic diagram showing chromatic dispersion and distortion of the photographic objective lens of FIG. 1; and

FIG. 4 is a graphic diagram showing modulation transfer function M.T.F characteristic the photographic objective lens of FIG. 1.

### DETAILED DESCRIPTION OF THE EMBODIMENTS

Embodiments of the invention are described more fully hereinafter with reference to the accompanying drawings, in which preferred embodiments of the invention are shown. The various embodiments of the invention may, however, be embodied in many different forms and should not be construed as limited to the embodiments set forth herein. Rather, these embodiments are provided so that this invention will be thorough and complete, and will fully convey the scope of the invention to those skilled in the art

It should be noted that the negative sign used herein means the ray propagates from left to right. Taking the intersection point of the spherical surface and the principal optical axis as a reference point, if the center of the spherical surface is in the left of the intersection point, the radius of curvature has a negative value, if, on the other hand, the center of the spherical surface is in the right of the intersection point, the radius of curvature has a positive value. In addition, in view of the ray propagating from left to right, one side on the left of the lens is referred as the object side, and the other side on the right of the lens is referred as the image side.

Unless otherwise specified, all terminologies and scientific terms used herein have the same meaning as normal sense understood by a technical person belonging to the technical field of the present invention. The terms used herein is for the purpose of describing particular embodiments only and is not intended to be limiting of the present invention. As used herein, the term “and/or” includes any and all combinations of one or more of the associated listed items.

The present disclosure discloses an photographic objective lens including, successively arranged along a transmission direction of an incident light: a first lens, which is a meniscus negative lens and includes a first curved surface and a second curved surface, both the first curved surface and the second curved surface are convex to an object side; a second lens which is a positive lens and includes a third curved surface and a fourth curved surface, both the third curved surface and the fourth curved surface are convex to an image side; a third lens which is a meniscus negative lens and includes a fifth curved surface and a sixth curved surface, both the fifth curved surface and the sixth curved surface are convex to the object side; a fourth lens which is a positive lens and includes a seventh curved surface and an eighth curved surface, the seventh curved surface is convex to the object side, and the eighth curved surface is convex to the image side; a fifth lens which is a double-concave negative lens and includes a ninth curved surface and a tenth curved surface, the ninth curved surface is convex to the image side, and the tenth curved surface is convex to the object side; a sixth lens which is a meniscus positive lens and includes an eleventh curved surface and a twelfth curved surface, both the eleventh curved surface and the twelfth curved surface are convex to the image side; a seventh lens which is a double-concave positive lens and includes a thirteenth curved surface and a fourteenth curved surface, the thirteenth curved surface is convex to the object side, and the fourteenth curved surface is convex to the image side; wherein the first to the seventh lenses are coaxially arranged along the transmission direction of the incident light, the first to the fourteenth curved surfaces are successively arranged along the transmission direction of the incident light; wherein the first to the seventh lenses have ratios of refractive index to Abbe number of 1.5/64, 1.67/32, 1.62/56, 1.63/55, 1.75/28, 1.62/60, and 1.62/60, with an allowable tolerance of 10%, an upper deviation of +5%, and a lower deviation of −5%.

The foregoing photographic objective lens and the photographic equipment can be directly used for underwater photography using the seawater (fresh water) as a medium of the photographic objective lens, therefore the sealing box is can be omitted. The advantages thereof includes a free framing, a large viewing range, a simple structure, and it can be sub-miniaturized, thus it is easy for assembly and storing.

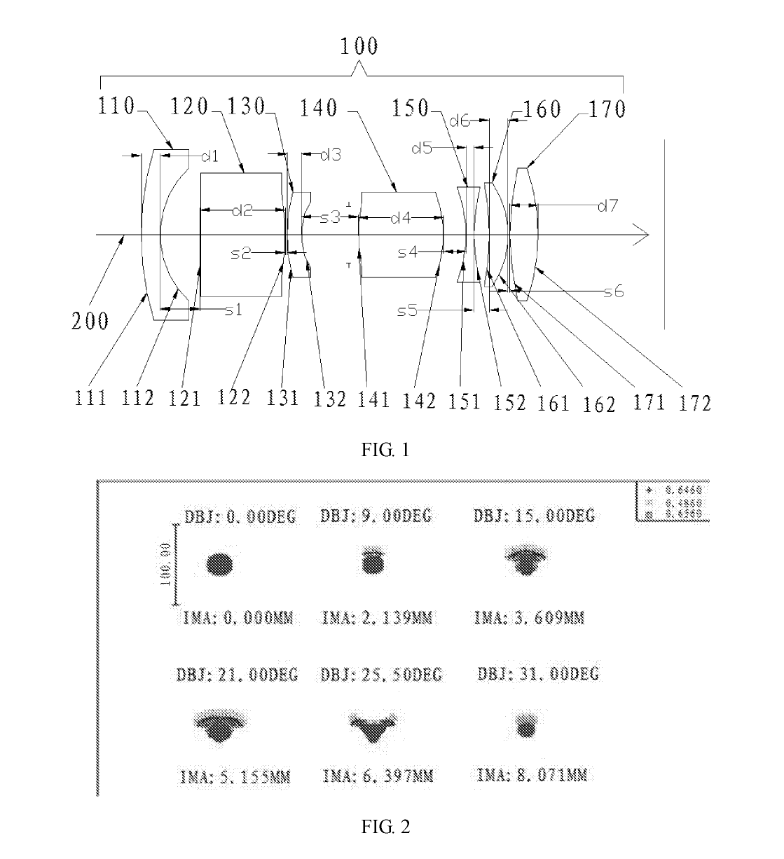

As shown in FIG. 1, the photographic objective lens 100 according to an embodiment includes seven lens successively arranged along a transmission direction of an incident light, which are a first lens 110, a second lens 120, a third lens 130, a fourth lens 140, a fifth lens 150, a sixth lens 160, and a seventh lens 170. The first lens 110 to the seventh lens 170 are coaxially arranged along the transmission direction of the incident light 200. The first curved surface 111 to the fourteenth curved surface 172 are successively arranged along the transmission direction of the incident light 200. The external diameters of the first lens 110 to the seventh lens 170 are less than 20 millimeters.

The first lens 110 is a meniscus negative lens and includes a first curved surface 111 and a second curved surface 112, both of which are spherical surfaces and convex to the object side. The first lens 110 has a ratio of refractive index to Abbe number of 1.5/64 (with a tolerance of ±5%), a radius of curvature of the first curved surface 111 is 75×(1±5%) millimeters, a radius of curvature of the second curved surface 112 is 10×(1±5%) millimeters. A central thickness dl of the first lens 110 along an optical axis is 4×(1±5%) millimeters. A clear aperture of the first lens 110 is 20×(1±5%) millimeters. The first lens 110 can be in direct contact with the seawater or fresh water.

The second lens 120 is a positive lens and includes a third curved surface 121 and a fourth curved surface 122, both of which are spherical surfaces and convex to the image side. The second lens 120 has a ratio of refractive index to Abbe number of 1.67/32 (with a tolerance of ±5%), a radius of curvature of the third curved surface 121 is −300×(1±5%) millimeters, a radius of curvature of the fourth curved surface is −30×(1±5%) millimeters. A central thickness d2 of the second lens 120 along an optical axis is 9×(1±5%) millimeters. A distance between the second lens 120 and the first lens 110, i.e. a central distance s1 between the third curved surface 121 and the second curved surface 112 along the optical axial is preferably 4×(1±5%) millimeters. A clear aperture of the second lens 112 is 12×(1±5%) millimeters.

The third lens 130 is a meniscus negative lens and includes a fifth curved surface 131 and a sixth curved surface 132, both of which are spherical surfaces and convex to the object side. The third lens 130 has a ratio of refractive index to Abbe number of 1.67/56 (with a tolerance of ±5%), a radius of curvature of the fifth curved surface 131 is 8.7×(1±5%) millimeters, a radius of curvature of the sixth curved surface 132 is 5.6×(1±5%) millimeters. A central thickness d3 of the third lens 130 along an optical axis is 2×(1±5%) millimeters. A distance between the third lens 130 and the second lens 120, i.e. a central distance s2 between the fifth curved surface 131 and the fourth curved surface 122 along the optical axial is preferably 0.2×(1±5%) millimeters. A clear aperture of the third lens 130 is 8×(1±5%) millimeters.

The fourth lens 140 is a positive lens and includes a seventh curved surface 141 and an eighth curved surface 142. The seventh curved surface 141 is a spherical surface and convex to the object side. The eighth curved surface 142 is a spherical surface and convex to the image side. The fourth lens 140 has a ratio of refractive index to Abbe number of 1.63/55 (with a tolerance of ±5%), a radius of curvature of the seventh curved surface 141 is 14.8×(1±5%) millimeters, a radius of curvature of the eighth curved surface 142 is −9×(1±5%) millimeters. A central thickness d4 of the fourth lens 140 along an optical axis is 7×(1±5%) millimeters. A distance between the fourth lens 140 and the third lens 130, i.e. a central distance s3 between the seventh curved surface 141 and the sixth curved surface 132 along the optical axial is preferably 4×(1±5%) millimeters. A clear aperture of the fourth lens 140 is 8×(1±5%) millimeters.

The fifth lens 150 is a double-concave negative lens and includes a ninth curved surface 151 and a tenth curved surface 152. The ninth curved surface 151 is a spherical surface and convex to the image side. The tenth curved surface 152 is a spherical surface and convex to the object side. The fifth lens 150 has a ratio of refractive index to Abbe number of 1.75/28 (with a tolerance of ±5%), a radius of curvature of the ninth curved surface 151 is −8.3×(1±5%) millimeters, a radius of curvature of the tenth curved surface 152 is 22×(1±5%) millimeters. A central thickness d5 of the fifth lens 150 along an optical axis is 1×(1±5%) millimeters. A distance between the fifth lens 150 and the fourth lens 140, i.e. a central distance s4 between the ninth curved surface 151 and the eighth curved surface 142 along the optical axial is preferably 2×(1±5%) millimeters. A clear aperture of the fifth lens 150 is 10×(1±5%) millimeters.

The sixth lens 160 is a meniscus positive lens and includes an eleventh curved surface 161 and a twelfth curved surface 162, both of which are spherical surfaces and convex to the image side. The sixth lens 160 has a ratio of refractive index to Abbe number of 1.62/60 (with a tolerance of ±5%), a radius of curvature of the eleventh curved surface 161 is −29×(1±5%) millimeters, a radius of curvature of the twelfth curved surface 162 is −9×(1±5%) millimeters. A central thickness d6 of the sixth lens 160 along an optical axis is 2×(1±5%) millimeters. A distance between the sixth lens 160 and the fifth lens 150, i.e. a central distance s5 between the eleventh curved surface 161 and the tenth curved surface 152 along the optical axial is preferably 1.5×(1±5%) millimeters. A clear aperture of the sixth lens 160 is 10×(1±5%) millimeters.

The seventh lens 170 is a double-concave positive lens and includes a thirteenth curved surface 171 and a fourteenth curved surface 172. Both the thirteenth curved surface 171 and the fourteenth curved surface 172 are spherical surfaces and convex to the image side. The seventh lens 170 has a ratio of refractive index to Abbe number of 1.62/60 (with a tolerance of ±5%), a radius of curvature of the thirteenth curved surface 171 is 28×(1±5%) millimeters, a radius of curvature of the fourteenth curved surface 172 is −23×(1±5%) millimeters. A central thickness d7 of the seventh lens 170 along an optical axis is 2.6×(1±5%) millimeters. A distance between the seventh lens 170 and the sixth lens 160, i.e. a central distance s6 between the twelfth curved surface 162 and the thirteenth curved surface 171 along the optical axial is preferably 0.2×(1±5%) millimeters. A clear aperture of the seventh lens 170 is 13×(1±5%) millimeters

In illustrated embodiment, the first lens 110 to the seventh lens 170 are rotationally symmetric about an axis of the incident light. Projections of the first lens 110 to the seventh lens 170 on a plane perpendicular to the incident light 200 are circulars. In alternative embodiments, the first lens 110 to the seventh lens 170 can also be non-rotational symmetry, i.e. projections of the first lens 110 to the seventh lens 170 on a plane perpendicular to the incident light 200 can also be ellipses, squares or other shapes

The photographic objective lens satisfies the following conditions: f=10 mm, D/f=1/3.0, 2ω=62°, wherein f is a focal length of the lens, D is an entrance pupil diameter, D/f is a relative aperture, and 2ω is an underwater visual field angle.

FIG. 2 is a graphic diagram showing astigmatism of the photographic objective lens of FIG. 1. In general, it is ideal for a viewing range of a focusing lens to be within 0.01 millimeters. The greatest geometry chromatic dispersion of the photographic objective lens of FIG. 1 is merely several micrometers, it can be seen that the image quality reaches an optimal level in the whole image surface.

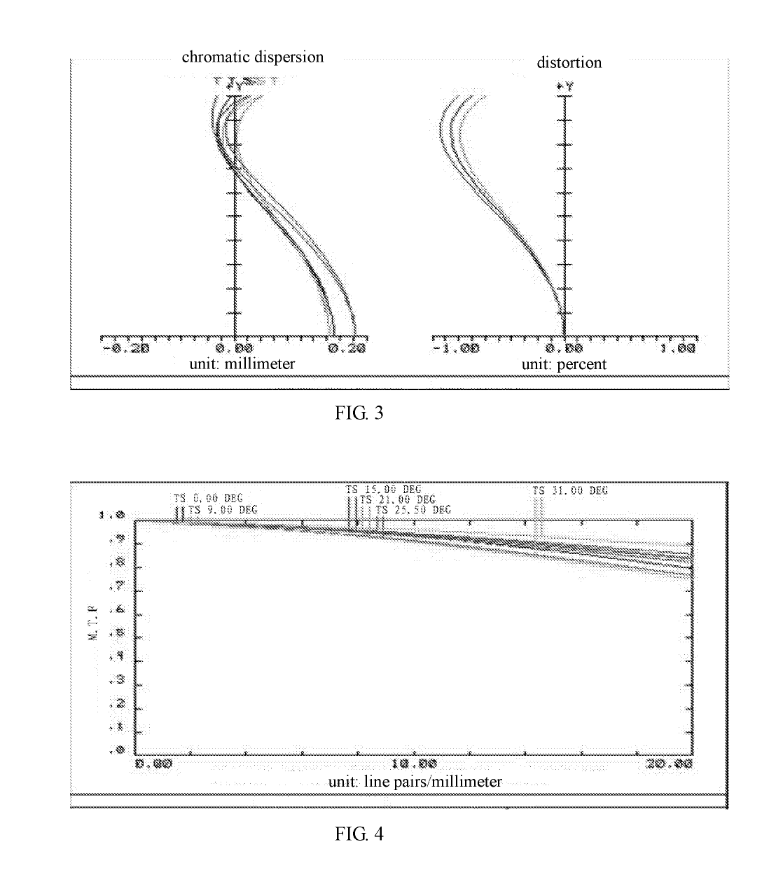

FIG. 3 is a graphic diagram showing chromatic dispersion and distortion of the photographic objective lens of FIG. 1. Both the XT, XS are very small and less than 0.3 millimeters. The distortion value is ideal, the greatest distortion value is less than 0.9%.

FIG. 4 is a graphic diagram showing modulation transfer function M.T.F characteristic the photographic objective lens of FIG. 1. The modulation transfer function is a method to objectively and thoroughly evaluate the imaging quality of the optical system. A ratio of the contrast of the output image to the contrast of the input image is named a modulation degree M.T.T, the modulation transfer function can be represented by M.T.F curve, the horizontal coordinate represents a resolution, the vertical coordinate represents a contrast. The M.T.F value ranges between 0 and 1, the greater the M.T.F value, the better the imaging quality of the system, and the clearer the image formed by the system. Referring to FIG. 3, the modulation transfer function M.T.F curve of the photographic objective lens mentioned above shows that, when the resolution reaches 20 line pairs per millimeter, the M.T.F is also greater than 0.75, it indicates that the photographic objective lens of the illustrated embodiment has a relative higher optical imaging quality which can expose fine lines. In fact, when the resolution reaches 30 line pairs per millimeter, the M.T.F is also greater than 0.6.

The disclosure further discloses a photographic equipment which includes foregoing photographic objective lens.

The foregoing photographic objective lens and the photographic equipment can be directly used for underwater photography using the seawater (fresh water) as a medium of the photographic objective lens, therefore the sealing box is can be omitted. The advantages thereof includes a free framing, a large viewing range, an underwater visual field angle thereof reaches 62 degrees which is equivalent to a visual field angle of 82 degrees on a wafer surface, the relative aperture is relative larger and reaches D/f=1/3.0. It has a simple structure and is sub-miniaturized (the external diameter of the photographic objective lens is relative small, and the overall length is no more than 50 millimeter), thus it is easy for assembly and storing. Because a requirement of a sealing box is eliminated, thus a full view of almost 360 degrees is obtained. It can be applied to a photographic system having a picture of one inch size, and is suitable for any light-sensitive medium, underwater photographic system such as CCD, photographic film.

The above are several embodiments of the present invention described in detail, and should not be deemed as limitations to the scope of the present invention. It should be noted that variations and improvements will become apparent to those skilled in the art to which the present invention pertains without departing from its spirit and scope. Therefore, the scope of the present invention is defined by the appended claims.

1. A photographic objective lens, comprising, successively arranged along a transmission direction of an incident light;
a first lens being a meniscus negative lens and comprising a first curved surface and a second curved surface, both the first curved surface and the second curved surface being convex to an object side;
the second lens being a positive lens and comprising a third curved surface and a fourth curved surface, both the third curved surface and the fourth curved surface being convex to an image side;
the third lens being a meniscus negative lens and comprising a fifth curved surface and a sixth curved surface, both the fifth curved surface and the sixth curved surface being convex to the object side;
the fourth lens being a positive lens and comprising a seventh curved surface and an eighth curved surface, the seventh curved surface being convex to the object side, and the eighth curved surface being convex to the image side;
the fifth lens being a double-concave negative lens and comprising a ninth curved surface and a tenth curved surface, the ninth curved surface being convex to the image side, and the tenth curved surface being convex to the object side;
the sixth lens being a meniscus positive lens and comprising an eleventh curved surface and a twelfth curved surface, both the eleventh curved surface and the twelfth curved surface being convex to the image side;
the seventh lens being a double-concave positive lens and comprising a thirteenth curved surface and a fourteenth curved surface, the thirteenth curved surface being convex to the object side, and the fourteenth curved surface being convex to the image side;
wherein the first to the seventh lenses are coaxially arranged along the transmission direction of the incident light, the first to the fourteenth curved surfaces are arranged along the transmission direction of the incident light in a sequence;
wherein the first to the seventh lenses have ratios of refractive index to Abbe number of 1.5/64, 1.67/32, 1.62/56, 1.63/55, 1.75/28, 1.62/60, and 1.62/60, with an allowable tolerance of 10%, an upper deviation of +5%, and a lower deviation of −5%.

2. The photographic objective lens according to claim 1, wherein a central distance between the second curved surface and the third curved surface, a central distance between the fourth curved surface and the fifth curved surface, a central distance between the sixth curved surface and the seventh curved surface, a central distance between the eighth curved surface and the ninth curved surface, a central distance between the tenth curved surface and the eleventh curved surface, and a central distance between the twelfth curved surface and the thirteenth curved surface are 4, 0.2, 4, 2, 1.5, and 0.2 millimeters, respectively, with an allowable tolerance of 10%, an upper deviation of +5%, and a lower deviation of −5%.

3. The photographic objective lens according to claim 1, wherein radiuses of curvature of the first to the fourteenth curved surfaces are 75, 10, −300, −30, 8.7, 5.6, 14.8, −9, −8.3, 22, −29, −9, 28, and −23 millimeters, respectively, with an allowable tolerance of 10%, an upper deviation of +5%, and a lower deviation of −5%

4. The photographic objective lens according to claim 1, wherein central thicknesses of the first to the seventh lenses are 4, 9, 2, 7, 1, 2, and 2.6 millimeters, respectively, with an allowable tolerance of 10%, an upper deviation of +5%, and a lower deviation of −5%.

5. The photographic objective lens according to claim 1, wherein clear apertures of the first to the seventh lenses are 20, 12, 8, 8, 10, 10, and 13 millimeters, respectively, with an allowable tolerance of 10%, an upper deviation of +5%, and a lower deviation of −5%

6. The photographic objective lens according to claim 1, wherein the first to the fourteenth curved surfaces are spherical surfaces.

7. The photographic objective lens according to claim 1, wherein external diameters of the first to the seventh lenses are less than 20 millimeters.

8. The photographic objective lens according to claim 1, wherein the first to the seventh lenses are rotational symmetry about an axis of the incident light.

9. The photographic objective lens according to claim 1, wherein the photographic objective lens satisfies the following conditions: f=10 mm, D/f=1/3.0, 2ω=62°, wherein f is a focal length of the lens, D is an entrance pupil diameter, D/f is a relative aperture, and 2ω is an underwater visual field angle.

10. A photographic equipment, comprising a photographic objective lens according to claim 1.
